(19) United States
(12) Patent Application Publication
(10) Pub. No.: US 2015/0149939 A1
(43) Pub. Date: May 28, 2015

(54) VARIABLE USER INTERFACE THEME CUSTOMIZATION

(71) Applicant: Cellco Partnership d/b/a Verizon Wireless, Basking Ridge, NJ (US)

(72) Inventors: Amir Mayblum, Walnut Creek, CA (US); Kim M. Gutierrez, Alameda, CA (US); Matthew Sibigtroth, Richmond, CA (US); Alisan Atvur, Oakland, CA (US); Amalia Sieber, San Francisco, CA (US); Jacob Gardner, Minneapolis, MN (US); Jen Yu, Redwood City, CA (US); Justin Lee, San Francisco, CA (US)

(73) Assignee: Cellco Partnership d/b/a Verizon Wireless, Basking Ridge, NJ (US)

(21) Appl. No.: 14/088,930

(22) Filed: Nov. 25, 2013

(51) Int. Cl. G06F 3/0484

(52) U.S. Cl. CPC G06F 3/0484
USPC 715/765

(57) ABSTRACT

A mobile device receives, from a user, parameters for a user interface theme associated with an application. The user interface parameters define conditions for altering features of the user interface theme based on variable data fields. The mobile device verifies compatibility of the user interface parameters, obtains data for the user interface parameters that corresponds to the variable data fields, and applies the obtained data to the user interface parameters to generate the features of the user interface theme. The mobile device also monitors the variable data fields to obtain updated data and applies the updated data to the user interface parameters to alter the features of the user interface theme.

### BACKGROUND

Mobile devices (e.g., cell phones, personal digital assistants (PDAs), etc.) may provide applications to accomplish a variety of communication and computational tasks. A user interface typically provides user operation and control mechanisms for these applications. Software components of the user interface may include a variety of features that can be altered to provide a preferred user experience.

### BRIEF DESCRIPTION OF THE DRAWINGS

FIG. 1 is a schematic illustrating an exemplary implementation of concepts described herein;

FIG. 2 is a diagram of an exemplary network in which systems and methods described herein may be implemented;

FIG. 3 depicts a diagram of an exemplary mobile device of the network of FIG. 2;

FIG. 4 depicts a diagram of exemplary components of the mobile device illustrated in FIG. 3;

FIG. 5 is a diagram of exemplary functional components of the mobile device illustrated in FIG. 3;

FIGS. 6A-8B illustrate exemplary user interface operations capable of being performed by the mobile device depicted in FIG. 2;

FIG. 9 is a schematic illustrating a user interface screen including a configuration menu for a variable user interface theme, according to an implementation described herein; and

FIG. 10 is a flow chart of an exemplary process for presenting a variable user interface, according to an implementation described herein.

### DETAILED DESCRIPTION OF PREFERRED EMBODIMENTS

The following detailed description refers to the accompanying drawings. The same reference numbers in different drawings may identify the same or similar elements.

Customization of a user interface is often viewed by a user as a cumbersome or extraneous process. In many cases, a user may configure user interface settings that remain unchanged after an application is initially installed or upgraded. This consistent user interface may provide familiarity, but lacks any variety or informative functionality. Systems and methods described herein may provide a customized, variable user interface theme for applications executed on a mobile device. A client program functions as a rule-based engine to customize the user interface theme of a particular application, such as a messaging application, a calendar application, etc. Each rule interpreted by the client program may be based on data provided to (or by) the mobile device. Rules may include parameters for colors (e.g., background colors, icon colors, frame colors, border colors, etc.), icons (e.g., pointers, virtual buttons, virtual keys, etc.), images (e.g., background images, etc.), fonts, and other customizable features. Data to be applied to the rules may be provided from a local memory or from a backend server via push or pull techniques.

According to implementations described herein, the client program may automatically present and/or update the user interface theme as dictated by new data applied to the rules. The client program may, for example, monitor particular feeds, data sources, or memory locations for new data that triggers changes to the user interface theme. In another implementation, the client program may receive user input to alter the user interface theme. Additionally, the client program may employ an algorithm that extracts color palette information from an image and applies the extracted colors to the customized theme.

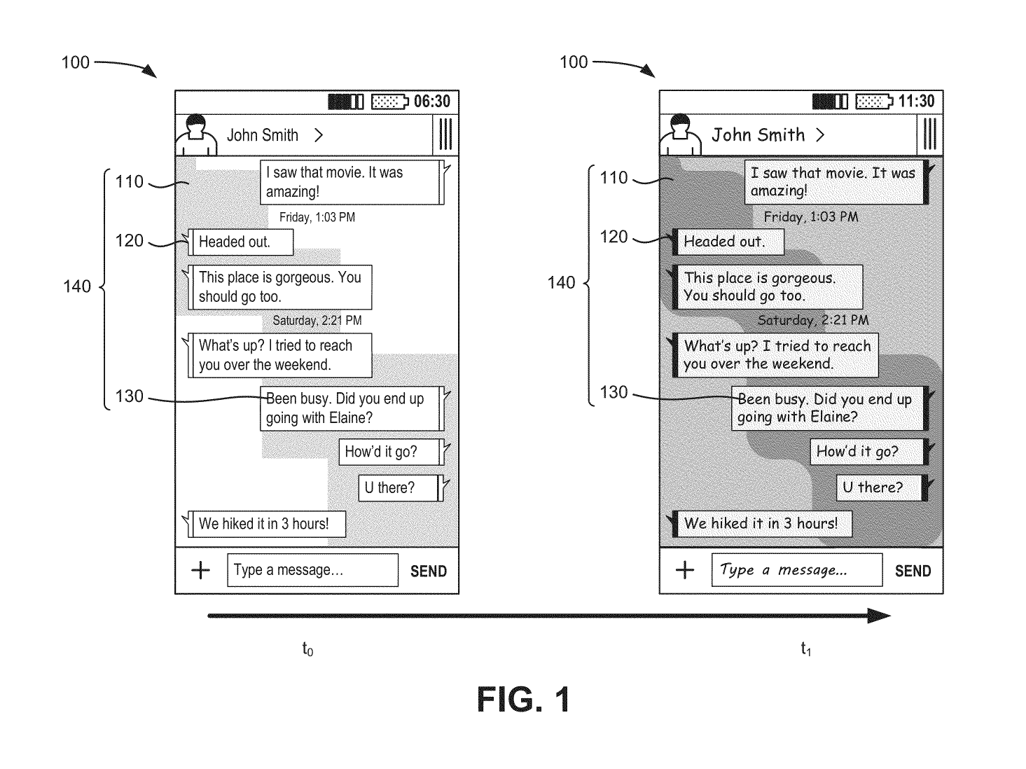

FIG. 1 is a schematic illustrating an exemplary implementation of a variable user interface theme, according to an implementation described herein. In one implementation, user interface 100 may be provided for a particular application on a mobile device. User interface 100 may be characterized by a background image 110, icons 120, fonts 130, and/or other presentation features, such as colors (collectively referred to herein as “presentation features 140”) that may be provided with different variations and different combinations to provide unique themes for user interface 100. Changes to presentation features 140 may be governed by applying selected data to rules for user interface 100.

In FIG. 1, user interface 100 is shown as a function of time progressing from time t₀ to time t₁. In the example of FIG. 1, presentation features 140 for user interface 100 may be modified based on input data for a time of day. In the example, of FIG. 1, a morning theme and a mid-day theme may be applied at different times, t₀ and t₁. For example, cool color tones (e.g., blue or white) may be applied to presentation features 140 for early morning hours at t₀ (e.g., 06:30 AM) and warmer color tones (e.g., yellow, orange, and red) may be applied to presentation features 140 toward mid-day at t₁ (e.g., 11:30 AM). Other color tones may be used for presentation features 140 for different times, such as darker color tones (e.g., dark blue, purple, black) at night.

Particular images (e.g., for background image 110), particular shapes (e.g., of icons 120) and particular fonts (e.g., of fonts 130) may also be changed in response to changing input data. In one implementation, the transition between user interface 100 at time t₀ and time t₁ may occur at a pre-defined time (e.g., according to a defined rule). In another implementation, the transition between user interface 100 at time t₀ and time t₁ may occur gradually over defined start and end times. For example, a color-scheme may gradually morph from a first color set to a second color set. In still another implementation, the color schemes may e changed based on a party/contact participating in a conversion (e.g., an instant message chat, voice call, etc.)

While FIG. 1 presents a relatively simple example of a rule-based temporal user interface, in other implementations, user interface 100 may be governed by more complex algorithms and types of applied data. Data provided to the device may include for, example, the following: time, location, location temperature, network connection, season, websites visited, number of text messages sent, number of text messages left in a messaging bundle, images viewed on the internet, images shared on the application, images stored locally on the device, images stored on the network, event data (e.g., sports scores, sport season, financial listings, weather updates, etc.), input from the user on how or when the theme should change, contacts in the address book, contact(s) in a conversation, etc. As described further herein, user interface 100 may be configured to respond to a variety of data types to modify an entire theme or individual presentation features 140. For example, one data type (e.g., time of day) may govern a type of background image 110, while a different data type (e.g., event data) may govern a color of background image 110.

Although FIG. 1 shows an exemplary user interface 100, in other implementations, user interface 100 may contain less, different, differently-arranged, or additional information than depicted in FIG. 1. For example, other features of user interface 100, such as sounds (e.g., notification sounds) or avatars, may also be modified in response to particular input data.

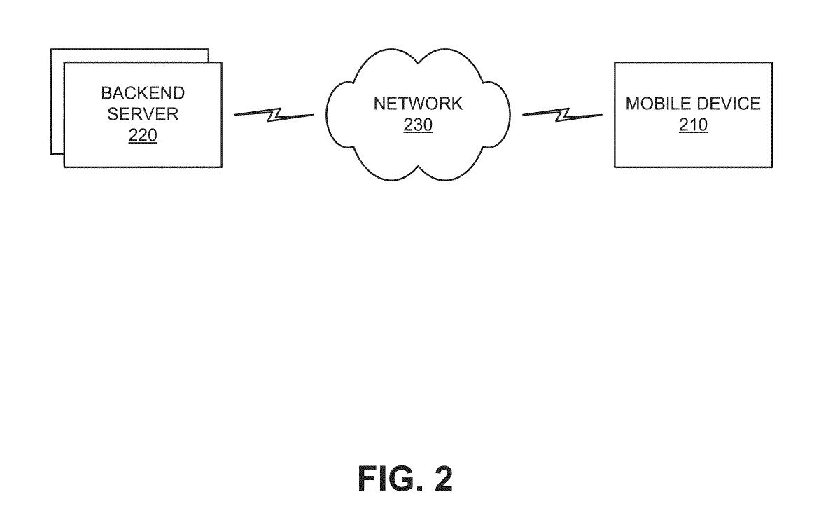

FIG. 2 is an exemplary network 200 in which systems and/or methods described herein may be implemented. As illustrated, network 200 may include a mobile device 210 and a backend server 220 interconnected by a communication network 230. Devices of network 200 may interconnect via wired and/or wireless links.

Mobile device 210 may include a computation or communication device capable of presenting a graphical user interface to a user. Mobile device 110 may include a smart phone, a tablet computer, a radiotelephone, a laptop computer, a gaming console, an e-reader device, a media player, or other types of computation or communication devices. Mobile device 110 may provide a communication interface to multiple types of networks (e.g., within communication network 230) including, for example, a wide area personal network (WPAN), a wireless local area network (WLAN), and/or a cellular network. Mobile device 210 may obtain data from backend server 220 via a push method or a pull method (e.g., periodically, reactively, proactively, etc.).

Backend server 220 may include one or more network devices, or other types of computation or communication devices, that gather, process, search, and/or provide information in a manner described herein. In one implementation, backend server 220 may be associated with a service provider that provides services (e.g., messaging services, data services, voice services, etc.) to mobile device 210. In one implementation, backend server 220 may provide data related to a customer's subscription (e.g., mobile data use, text messaging use, voice minute use, etc.) to mobile device 210. In another implementation, backend server 220 may provide data related to other resources, as indicated by configuration settings for user interface 100. For example, backend server 220 may provide data related to a particular universal resource locator (URL) (e.g., a particular data field from a web page), a data feed, a ticker symbol, etc. In another implementation, backend server 220 may receive login requests from mobile device 210 and/or verify credentials from mobile device 210 before providing data to mobile device 210.

Communication network 230 may include one or more networks including a cellular network, a satellite network, the Internet, a telephone network, such as the Public Switched Telephone Network (PSTN), a metropolitan area network (MAN), a wide area network (WAN), a local area network (LAN), a mesh network, or another type of network. In an exemplary implementation, communication network 230 may include a combination of networks including a cellular network that uses components for transmitting data to and from mobile device 210 and backend server 220. Such components may include base station antennas (not shown) that transmit and receive data from communication devices within their vicinity. Such components may also include base stations (not shown) that connect to the base station antennas and communicate with other devices, such as switches and routers (not shown) in accordance with known techniques.

Although FIG. 2 shows exemplary components of network 200, in other implementations, network 200 may contain fewer, different, differently-arranged, or additional components than depicted in FIG. 2. For example, there may be thousands or millions of mobile devices 210.

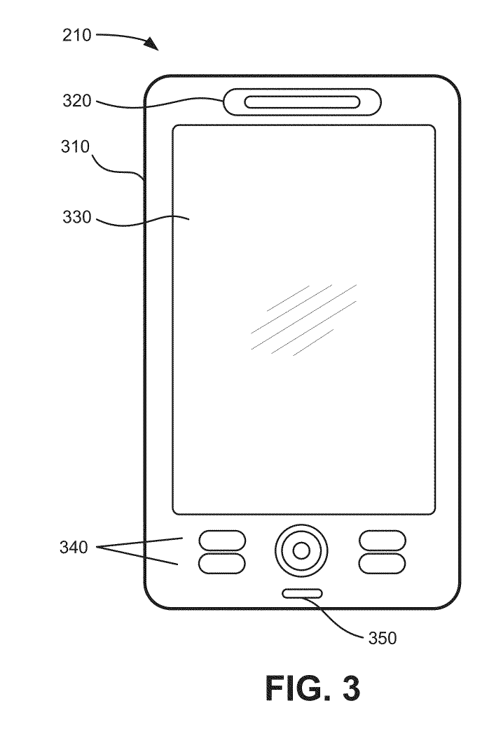

FIG. 3 is a diagram of an exemplary mobile device 210 in which systems and methods described herein may be implemented. As illustrated in FIG. 3, device 300 may include a housing 310, a speaker 320, a display 330, control buttons 340, and/or a microphone 350. Housing 310 may protect the components of device 300 from outside elements. Housing 310 may include a structure configured to hold devices and components used in mobile device 210, and may be formed from a variety of materials. For example, housing 310 may be formed from plastic, metal, or a composite, and may be configured to support speaker 320, display 330, control buttons 340 and/or microphone 350.

Speaker 320 may provide audible information to a user of device 300. Speaker 320 may be located in an upper portion of device 300, and may function as an ear piece when a user is engaged in a communication session using device 300. Speaker 320 may also function as an output device for music and/or audio information associated with games and/or video images played on mobile device 210.

Display 330 may provide visual information to the user. For example, display 330 may display text inputted into mobile device 210, text, images, video, and/or graphics received from another device, and/or information regarding incoming or outgoing calls or text messages, emails, media, games, phone books, address books, the current time, etc. For example, display 330 may include a liquid crystal display (LCD), such as a thin film transistor (TFT) LCD, etc.

In one implementation, display 330 may include a touch screen display that may be configured to receive a user input when the user touches (or comes in close proximity to) display 330. For example, the user may provide an input to display 330 directly, such as via the user's finger, or via other devices, such as a stylus. User inputs received via display 330 may be processed by components and/or devices operating in mobile device 210. The touch-screen-enabled display 330 may permit the user to interact with mobile device 210 in order to cause mobile device 210 to perform one or more operations. Exemplary technologies to implement a touch screen on display 330 may include, for example, a near-field-sensitive (e.g., capacitive) overlay, an acoustically-sensitive (e.g., surface acoustic wave) overlay, a photo-sensitive (e.g., infra-red) overlay, a pressure sensitive (e.g., resistive) overlay, and/or any other type of touch panel overlay that allows display 330 to be used as an input device. The touch-screen-enabled display 330 may also include the ability to identify movement of a body part or a pointing device as it moves on or near the surface of the touch-screen-enabled display 330.

Control buttons 340 may permit the user to interact with device 300 to cause device 300 to perform one or more operations. For example, control buttons 340 may be used to cause device 300 to transmit information. Microphone 350 may receive audible information from the user. For example, microphone 350 may receive audio signals from the user and may output electrical signals corresponding to the received audio signals.

Although FIG. 3 shows exemplary features of mobile device 210, in other implementations, mobile device 210 may contain fewer, different, differently arranged, or additional features than depicted in FIG. 3. For example, in some implementations device 300 may include a keypad, such as a standard telephone keypad, a QWERTY-like keypad (e.g., a traditional configuration of typewriter or computer keyboard keys), or another keypad layout.

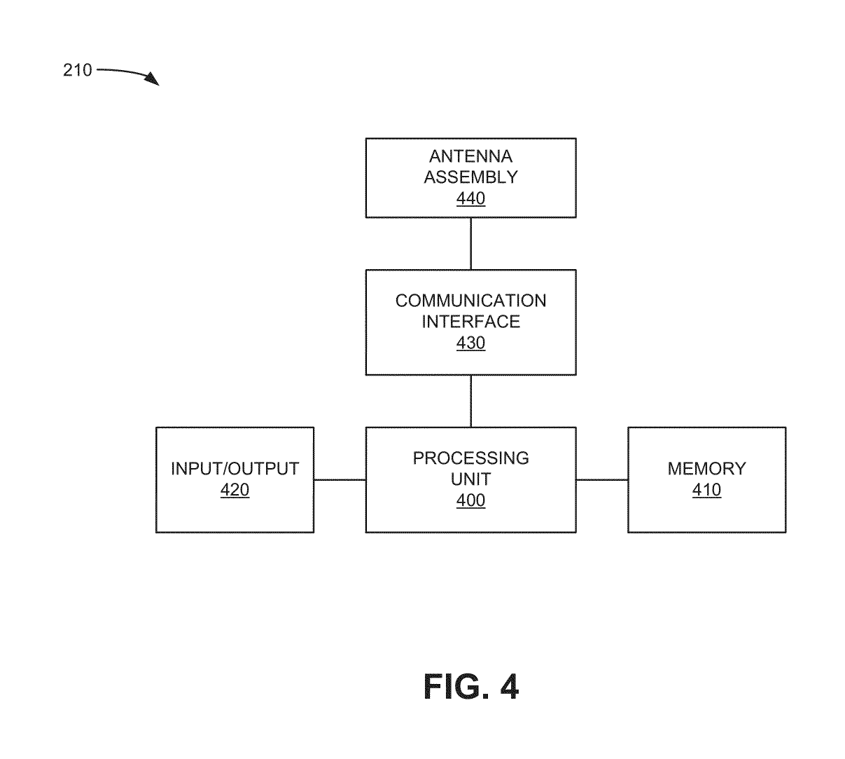

FIG. 4 is a diagram of exemplary components of mobile device 210. As illustrated, mobile device 210 may include a processing unit 400, a memory 410, input/output 420, a communication interface 430, and/or an antenna assembly 440.

Processing unit 400 may include one or more microprocessors, application specific integrated circuits (ASICs), field programmable gate arrays (FPGAs), or the like. Processing unit 400 may control operation of mobile device 210 and its components. In one implementation, processing unit 400 may control operation of components of mobile device 210 in a manner described herein.

Memory 410 may include a random access memory (RAM), a read-only memory (ROM), and/or another type of memory to store data and instructions that may be used by processing unit 400. In one implementation, memory 410 may store data used to display a graphical user interface, such as user interface 100 on display 330.

Input/output 420 may include mechanisms for inputting information to mobile device 210 and/or for outputting information from mobile device 210. Examples of input and output mechanisms might include buttons (e.g., control buttons 340, keys of a keypad, a joystick, etc.); a speaker (e.g., speaker 320) to receive electrical signals and output audio signals; a microphone (e.g., microphone 350) to receive audio signals and output electrical signals; a display (e.g., display 330) to receive touch input and/or to output visual information (e.g., communication items received by mobile device 210); a vibrator to cause mobile device 210 to vibrate; and/or a camera to receive video and/or images.

Communication interface 430 may include, for example, a transmitter that may convert baseband signals from processing unit 400 to radio frequency (RF) signals and/or a receiver that may convert RF signals to baseband signals. Alternatively, communication interface 430 may include a transceiver to perform functions of both a transmitter and a receiver. Communication interface 430 may connect to antenna assembly 440 for transmission and/or reception of the RF signals.

Antenna assembly 440 may include one or more antennas to transmit and/or receive RF signals over the air. Antenna assembly 440 may, for example, receive RF signals from communication interface 430 and transmit them over the air, and receive RF signals over the air and provide them to communication interface 430. In one implementation, for example, communication interface 430 may communicate with a network and/or devices connected to a network.

As will be described in detail below, mobile device 210 may perform certain operations described herein in response to processing unit 400 executing software instructions of an application contained in a computer-readable medium, such as memory 410. A computer-readable medium may include a tangible, non-transitory memory device. A memory device may include space within a single physical memory device or spread across multiple physical memory devices. The software instructions may be read into memory 410 from another computer-readable medium or from another device via communication interface 430. The software instructions contained in memory 410 may cause processing unit 400 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of mobile device 210, in other implementations, mobile device 210 may contain fewer, different, differently-arranged, or additional components than depicted in FIG. 4. In still other implementations, a component of mobile device 210 may perform one or more other tasks described as being performed by another component of mobile device 210.

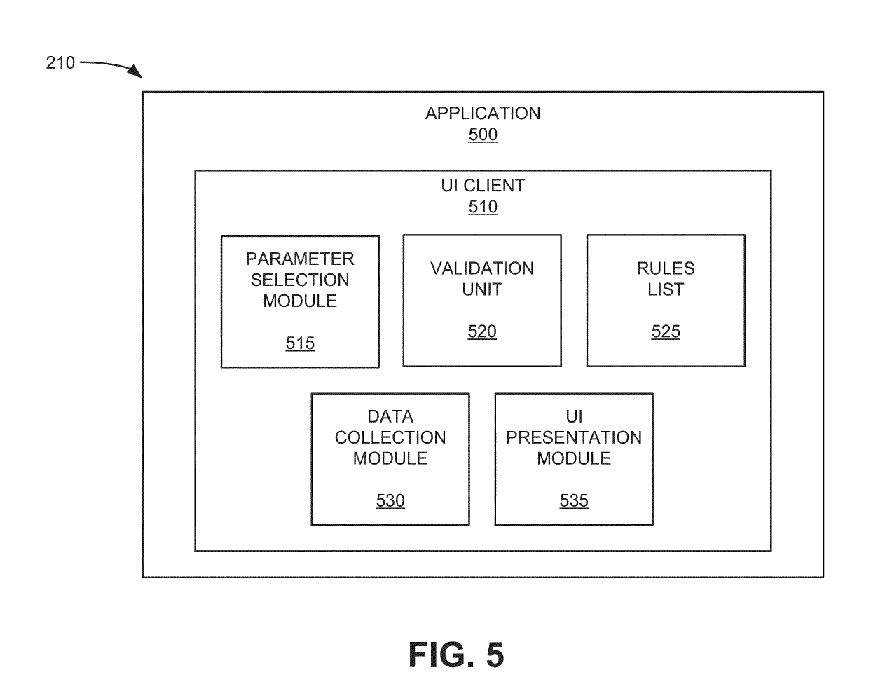

FIG. 5 is a block diagram of exemplary functional components of mobile device 210. In one implementation, the functions described in connection with FIG. 5 may be performed by one or more components of mobile device 210 (FIG. 4). Some or all of the functional blocks of FIG. 5 may be included, for example, in an application (e.g., software), stored in memory 410 and executed by processing unit 400. Functional components of mobile device 210 may generally allow mobile device 210 to provide a customized user interface theme for an application executed on mobile device 210. As shown in FIG. 5, mobile device 210 may include an application 500 that includes a user interface (UI) client 510. User interface client 510 may include a parameter selection module 515, a validation unit 520, a rules list 525, a data collection module 530, and a UI presentation module 535.

Application 500 may include any application that provides a graphical user interface for user of mobile device 210. Application 500 may include, for example, a messaging application, a calendar application, a browser application, etc. Application 500 may include user interface features, such as colors, borders, icons, backgrounds, and other features, that may be customized for a particular user.

User interface client 510 may include, for example, a client application (e.g., a upgrade or add-on) for application 500. Generally, user interface client 510 may enable a user to input parameters for variations to user interface 100, correlate the input parameters to features of user interface 100, collect data to apply to the parameters, and present user interface 100 based on collected data applied to the parameters. In one implementation, user interface client 510 may provide a rule-based engine to customize the user interface theme of a particular application based on changing input data.

Parameter selection module 515 may provide a menu to solicit personalized selections for user interface 100. For example, selection module 515 may present a selection menu for features of the graphical presentation of application 500 that can be varied. In one implementation, parameter selection module 515 may solicit a variable range for each feature. The variable range may include, for example, a start color and an end color, a starting font and an ending font, a starting background and an ending background, a start brightness level and an end brightness level, etc. In one implementation, the variable range may include intermediate levels for colors, fonts, backgrounds, brightness, etc. In another implementation, as described further herein, the variable range may be tied to an item or image from which variable information may be extracted.

Parameter selection module 515 may also solicit user input for parameters associated with the selected variable ranges for each feature. For example, variable ranges may be tied to a particular data field. The data field be selected from local data (e.g., stored and/or updated by local on mobile device 210) or remote data (e.g., stored and/or updated by backend server 220). The data field may include, for example, non-personal data (e.g., time of day, local temperature, season, local weather, local traffic congestion, sports scores/results, etc.) or subscriber-specific data (e.g., a number of text messages sent/available for a monthly subscription bundle, available data remaining for monthly subscription bundle, number of unread messages, network connection strength, recent/current communications with address book contacts, recent images viewed/captured, etc.). As an illustrative example, parameter selection module 515 may receive a variable range for a background color of green to red. The user may define parameters for green as more than 50% of an available monthly pre-paid messaging allotment for the user's subscription and for red as less than 50% of the available monthly pre-paid messaging allotment.

In one implementation, parameter selection module 515 may enable a theme-based selection (e.g., that includes a group of backgrounds, icons, color schemes, and/or sounds) that permit a user to define features and parameters for changing each feature as a group. That is, multiple features may be tied to a single variable. In another implementation, parameter selection module 515 may enable a user to define multiple features and variables as a single theme. That is, a single theme may include multiple features tied to multiple variables.

Parameter selection module 515 may receive user input in any of a variety of formats. In one implementation, parameter selection module 515 may include a menu-driven interface to select from a group of available features and combinations. The menu-driven interface may presented as a “wizard”-type interface to guide users through a logical selection process. In another implementation, parameter selection module 515 may be configured to accept code for variable background rules, such as peer generated code. For example, mobile device users may share code via social network platforms, dedicated forums, or on an ad hoc basis. The shared code may be inserted, for example, as a text file that may be provide theme definitions for parameter selection module 515. In still another implementation, new XML code may be entered (e.g. via a text input) to implement particular user interface themes. In still another application, parameter selection module 515 may communicate with backend server 220 to provide additional guidance to configure a theme definition.

Validation unit 520 may ensure that rules from parameter selection module (e.g., variable ranges and data parameters that are provided by a user) are compatible. For example, validation unit 520 may verify that a variable range/data field combination for an active rule associated with a particular feature does not conflict with another variable range/data field for active rule. As an illustrative example, validation unit 520 may detect inconsistencies between a background color dictated by one parameter and a background image dictated by another parameter that may override the background color. As another example, validation unit 520 may detect if a single feature may be governed by different rules simultaneously.

Assuming the user input is validated by validation unit 520, parameter selection module 515 may store user input for variable ranges and data fields in rules list 525 for varying user interface 100 for application 500. Rules list 525 may include, for example, rules related to individual user interface features indicated via parameter selection module 515 or multiple features associated with a single theme.

Data collection module 530 may obtain data to apply to variables in rules list 525 to generate and/or update user interface 100. In one implementation, data collection module 530 may retrieve data from a remote or local source at periodic intervals. For example, data collection module 530 may poll a data source for updates every minute, every five minutes, etc. In another implementation, data collection module 530 may receive data feeds that push data from a remote source (e.g., backend server 220). In one implementation, data collection module 530 may provide credentials (e.g., an account name and password) to backend server 220 for the particular mobile device 210 to register to receive data updates from backend server 220. Data collection module 530 may receive credentials from a user and store the credentials in a local memory for use during subsequent data requests. In another aspect, backend server 220 may request credentials from mobile device 210. The registration process may be automated (e.g., without requiring intervention from the user of mobile device 210) or may require explicit user authorization (e.g., may solicit input from the user of mobile device 210) on a first instance.

In one implementation, data collection module 530 may employ an algorithm that extracts color palette information from an image and provides the results of the different colors present in the image to UI presentation module 535 for use in a customized theme. The algorithm may extract color palette information from images such as those searched on the Internet, shared in conversations on the application, stored locally on the device, and/or stored on a network cloud. The predominant colors from a particular image may be used as a parameter for the user interface theme. Additionally, or alternatively, data collection module 530 may use an actual image as a background image and apply brightness, contrast, gamma, transparency, blurring, and/or noise reduction effects to the image, as governed by rules list 525. In another implementation, a user may identify one or more particular images for data collection module 530 to extract color palette information.

UI presentation module 535 may apply data obtained from data collection module 530 to parameters defined in rules list 525. Changes in the data may cause UI presentation module 535 to modify the appearance of user interface 100. In one implementation, UI presentation module 535 may modify several user interface features based on a single data type. In another implementation, UI presentation module 535 may modify different user interface features, independent of each other, based on different data types.

Although FIG. 5 shows exemplary functional components of mobile device 210, in other implementations, mobile device 210 may contain fewer, different, or additional functional components than depicted in FIG. 5.

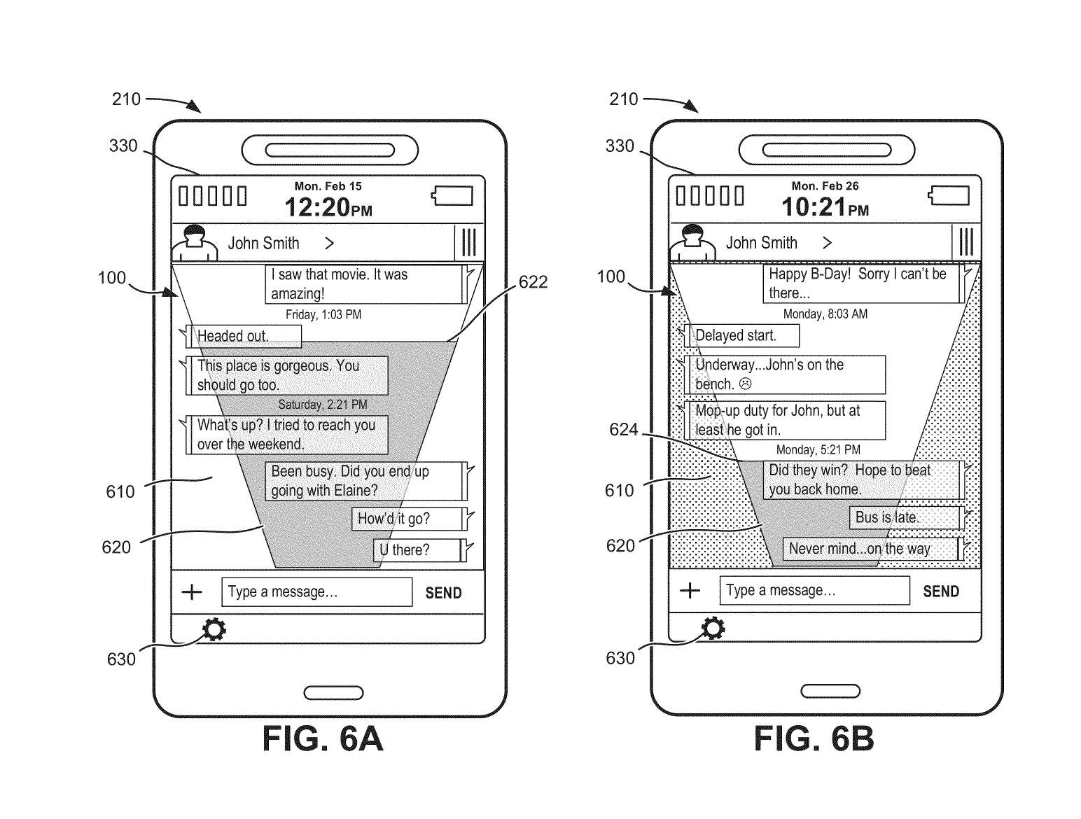

FIGS. 6A-8B illustrate exemplary user interface operations capable of being performed by the mobile device. Operations may be performed for example, using user interface client 510 of application 500 operating on processing unit 400. FIGS. 6A-8B provide a view of variable user interface 100 presented on display 330 of mobile device 210. User interface 100 may include features consistent with those described above with respect to FIG. 1.

In FIGS. 6A and 6B, user interface 100 is shown with a background image that may be associated with data from a subscriber's account. For example, user interface client 510 may apply rules (e.g., from rules list 525) to present a background 610 based on account data. Background 610 may include, for example, an indicator 620 that represents a remaining amount of a limited service associated with a subscription, such as a pre-paid message limit, a monthly voice minute allowance, or a monthly data allowance. In one implementation, user interface client 510 (e.g., data collection module 530) may retrieve updated subscription information (e.g., remaining texts, data, minutes, etc.) from backend server 220 to allow updated information to be reflected in background 610. In another implementation, user interface client 510 (e.g., data collection module 530) may retrieve estimated subscription information from a local memory (e.g., associated with application 500).

In the example of FIGS. 6A and 6B, indicator 620 may change over time to reflect current data. Referring to FIG. 6A, indicator 620 may represent a usage level with approximately 75% of a subscriber's allotted monthly limit remaining, as indicated by line 622. Referring to FIG. 6B, at a later point in time, indicator 620 may represent a usage level with approximately 30% of the subscriber's allotted monthly limit remaining, as indicated by line 624. As further shown in FIG. 6B, a color of background 610 may also change to reflect, for example, thresholds associated with the subscriber's allotted monthly limit or an unrelated parameter (e.g., time of day, season, etc.), as governed by a rule in rules list 525. In other implementations, indictor 620 may also include numbers that correlate to the actual data.

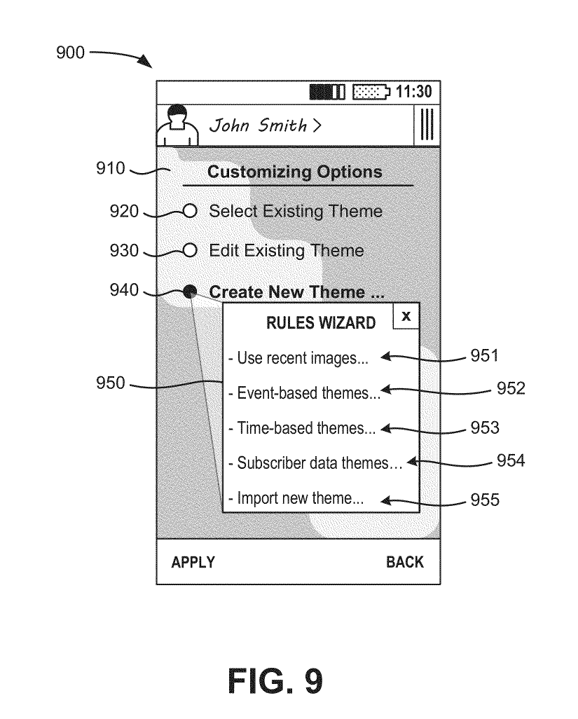

As further shown in FIGS. 6A and 6B, user interface 100 may also include a configuration settings option 630. As described further herein (e.g., in connection with FIG. 9), configuration settings option 630 may be selected by a user to select parameters for variable user interface 100.

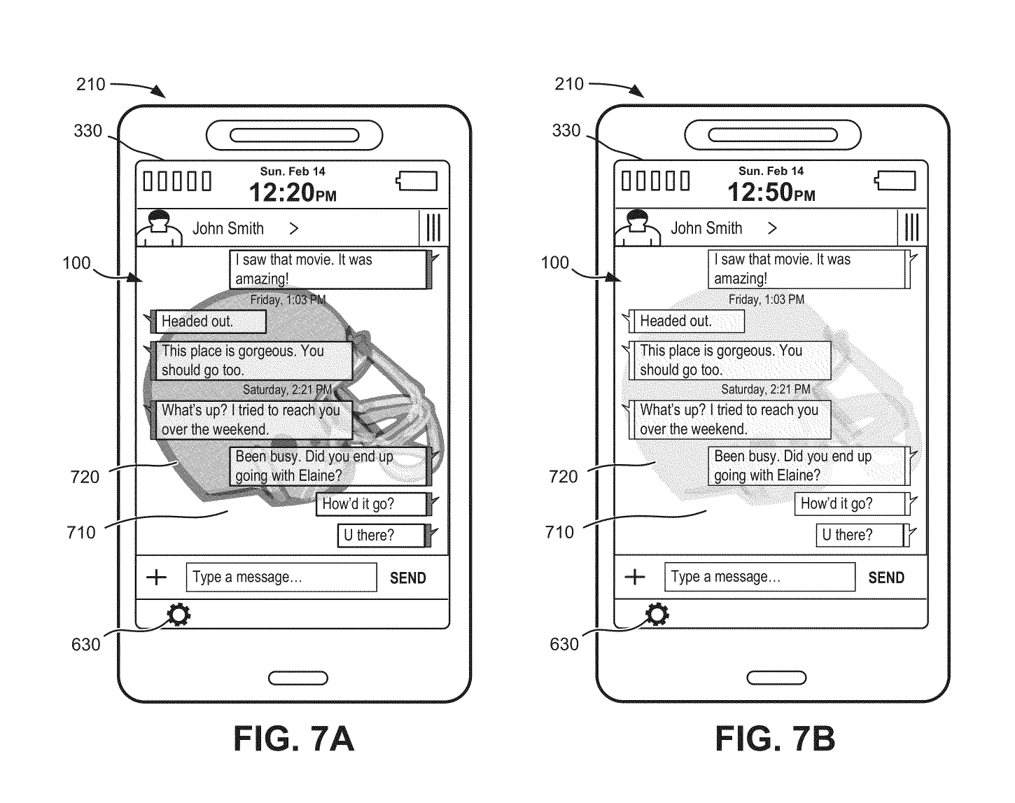

In FIGS. 7A and 7B, user interface 100 is shown with a background image that may be associated with data from an event or entity (e.g., an event/entity not otherwise associated with mobile device 210). For example, user interface client 510 may apply rules (e.g., from rules list 525) to present a background 710 based on event data or a feed from an entity. Background 710 may include, for example, an image 720 that represents a sports team, organization, etc. In one implementation, user interface client 510 may modify image 720 based on rules list 525. For example, user interface client 510 may change a color or intensity of image 720 based on a score/result of a particular sports team. User interface client 510 (e.g., data collection module 530) may retrieve updated event/entity information (e.g., a score, league standings, player statistics, etc.) from backend server 220, a designated RSS feed, or another server (not shown).

Referring to FIG. 7A, image 720 may represent particular sports team selected by a subscriber. The color and/or intensity of image 720 may be brighter when data indicates the particular team has won or is leading a most recent contest. Referring to FIG. 7B, at a later point in time, image 720 may be dimmer when data indicates the particular team has lost or is trailing a most recent contest. Additionally, or alternatively, other features (e.g., background, icons, etc.) of user interface 100 also change to reflect the event/entity data, as designated in rules list 525.

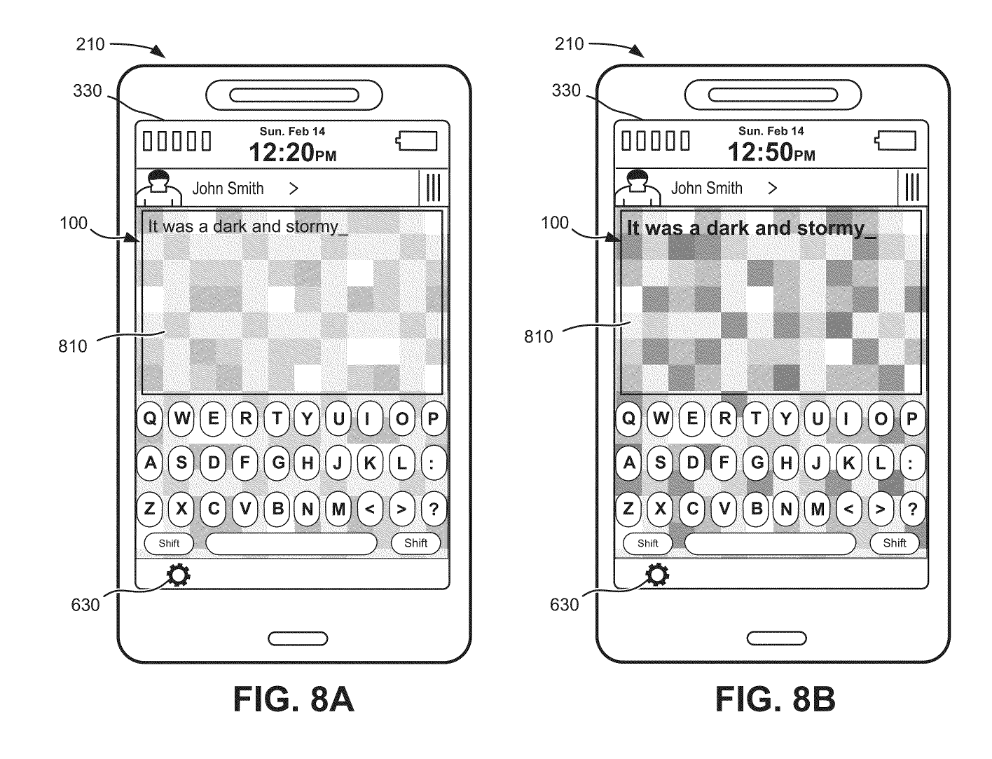

In FIGS. 8A and 8B, user interface 100 is shown with a background image that may be associated with images viewed by a user of mobile device 210. For example, user interface client 510 may apply rules (e.g., from rules list 525) to present a background 810 based on images in memory 410, such as a browser cache, downloads folder, or camera folder. Background 810 may include, for example, a pattern that can be modified to incorporate different colors (e.g., colors from recent photographs). In one implementation, for example, user interface client 510 may extract a color palette from a most recently taken/received photograph by mobile device 210. User interface client 510 may change background 810 based on subsequently obtained images, as governed by rules list 525.

Referring to FIG. 8A, background 810 may represent a color palette extracted from a particular photograph taken earlier in a day. The colors used in background 810 in FIG. 8A may be predominant colors extracted from the image. Referring to FIG. 8B at a later point in time, user interface client 510 may modify colors background 810 to incorporate color extracted from a more recently received image. Additionally, or alternatively, other features (e.g., background image, icons, etc.) of user interface 100 may also be changed to reflect colors extracted from an image, as designated in rules list 525.

Although FIGS. 6A-8B show exemplary variable user interface operations associated with mobile device 210, in other implementations, mobile device 210 may perform fewer, different, or additional operations than depicted in FIGS. 6A-8B.

FIG. 9 is a schematic illustrating a user interface screen 900 including a configuration menu 910 for a variable user interface theme, according to an implementation described herein. According to one implementation, configuration menu 910 may be presented by parameter selection module 515 (e.g., in response to selection of configuration settings option 630 of user interface 100). In one implementation, configuration menu 910 may be provided for a particular application running on mobile device 210. Configuration menu 910 may include a select existing theme option 920, an edit existing them option 930, and a create new theme option 940.

Select existing theme option 920 may provide a sub-menu (not shown) to allow a user to select from previously stored variable themes (e.g., stored in rules list 525). Edit existing them option 930 may provide a sub-menu (not shown) to enable a user to edit a previously-stored variable theme (e.g., from rules list 525).

User selection of create new theme option 940 may cause user interface client 510 to present a configuration menu (or “rules wizard” menu) 950 to configure a new theme. In one implementation, configuration menu 950 may provide options of rules templates that may be used to generate variable themes based on different types of data/parameters. For example, configuration menu 950 may include options for a rule template to use recent images 951, a rule template to use event-based themes 952, a rule template for time-based themes 953, a rule template for subscriber data themes 954, and an option to import a new theme 955.

Recent images option 951 may provide a menu or series of menus to solicit image locations and parameters for displaying a user interface theme based on images from the selected locations. In one implementation, rules template option 951 may also solicit image properties for images to be used as a background. Background images may include, for example, actual images or background patterns to which color schemes from actual images have been applied.

Event-based option 952 may provide a menu or series of menus to solicit event types, data locations, and parameters for displaying a user interface theme based on data from an event. In one implementation, event-based option 952 may include different rule templates for different categories of events. Categories of events may include, for example, sporting events (e.g., scores/results for particular teams, individual player statistics, etc.), weather events (e.g., local temperatures, forecasts, watches/warnings, etc.), financial events (e.g., index performance, portfolio balances, individual stock values, etc.).

Time-based option 953 may provide a menu or series of menus to solicit event time periods, variable features, and/or other parameters for displaying a user interface theme based on times. According to different implementations, configurable time periods may include daily time periods, days of the week, months, seasons, etc.

Subscriber data option 954 may provide a menu or series of menus to solicit data types and/or data sources for subscriber data that may be used to display a user interface theme based on subscriber account information. For example, subscriber data option 954 may solicit activities to be tracked for the subscriber's account (e.g., mobile data use, text messaging use, voice minute use, etc.) and features (e.g., colors, background images, etc.) to associate with particular use thresholds for those activities.

Import new theme option 955 may provide a menu or series of menus to solicit a source/location for customized rules. For example, import new theme option 955 may solicit a location for peer-generated code that may include ad hoc rules for variable backgrounds.

In another implementation, create new theme option 950 may provide a user interface to manage and/or combine different types of rules. Validation unit 525, for example, may analyze the different rules to ensure each selected rule can function without conflicting another selected rule.

Although FIG. 9 shows an exemplary user interface 900 for configuring a variable user interface theme, in other implementations, user interface 900 include fewer, different, or additional options than depicted in FIG. 9.

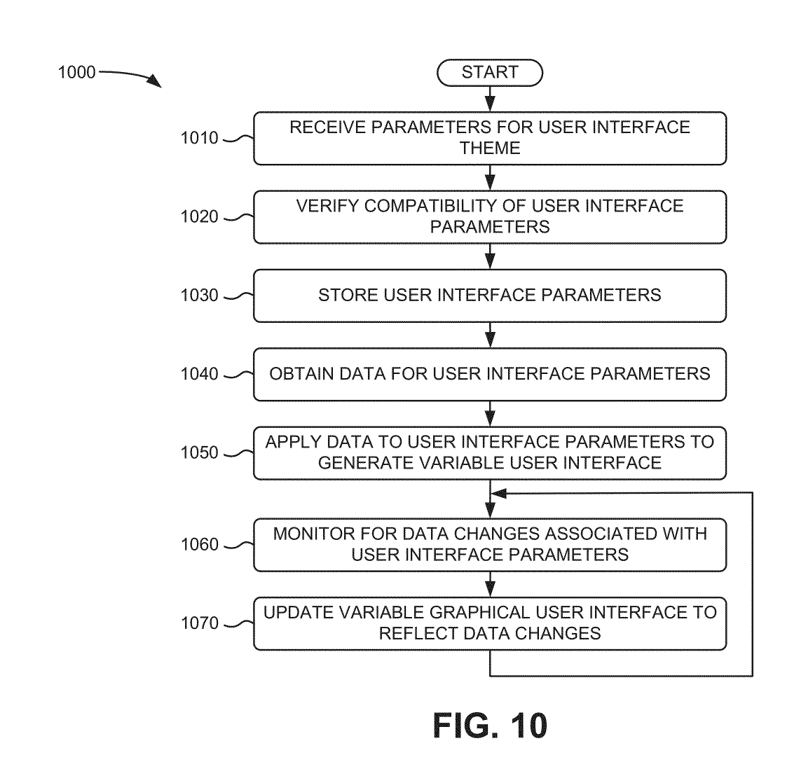

FIG. 10 depicts a flow chart of an exemplary process 1000 for presenting a variable user interface according to implementations described herein. In one implementation, process 1000 may be performed by mobile device 210.

As illustrated in FIG. 10, process 1000 may include receiving parameters for a user interface theme (block 1010). For example, user interface client 510 (e.g., selection module 515) operating on mobile device 210 may present a selection menu (e.g., configuration menu 910) for features of the graphical presentation of application 500 that can be varied. In one implementation, user interface client 510 may solicit a variable range for each feature or a group of features. The variable range may include, for each feature, a start color and an end color, a starting font and an ending font, a starting background and an ending background, a start brightness level and an end brightness level, etc. User interface client 510 may also solicit user input for parameters associated with the selected variable ranges for each feature. For example, variable ranges may be tied to a particular data field, such as time, particular event data, subscriber account, data, etc.

Process 1000 may also include verifying compatibility of the user interface parameters (block 1020) and storing the user interface parameters (block 1030). For example, user interface client 510 (e.g., validation unit 525) may ensure that rules in rules list 525 (e.g., variable ranges and data parameters that are provided by a user) are compatible. User interface client 510 may verify that a variable range/data field combination for an active rule associated with a particular feature does not conflict with another variable range/data field for the active rule. User interface client 510 may store parameters for the user interface theme may be stored, for example, in rules list 525.

Process 1000 may further include obtaining data for the user interface parameters (block 1040) and applying the data to the user interface parameters to generate a variable graphical user interface (block 1050). For example, user interface client 510 (e.g., data collection module 530) may obtain data to apply to variables in rules list 525 to generate user interface 100. User interface client 510 (e.g., UI presentation module 535) may apply the obtained data to parameters defined rules list 525.

Process 1000 may additionally include monitoring for data changes associated with the user interface parameters (block 1060) and updating the variable graphical user interface to reflect the data changes (block 1070). For example, user interface client 510 (e.g., data collection module 530) may obtain data to apply to variables in rules list 525 to update user interface 100. In one implementation, user interface client 510 may retrieve data from a remote or local source at periodic intervals. In another implementation, user interface client 510 may receive data feeds that push data from a remote source (e.g., backend server 220). Changes in the data may cause user interface client 510 (e.g., UI presentation module 535) to modify the appearance of user interface 100.

Systems and methods described herein may receive, from a user, parameters for a user interface theme associated with an application. The user interface parameters may define conditions for altering features of the user interface theme based on variable data fields. The systems and methods may verify compatibility of the user interface parameters, obtain data for the user interface parameters that corresponds to the variable data fields, and apply the obtained data to the user interface parameters to generate the features of the user interface theme. The systems and methods may also monitor the variable data fields to obtain updated data and apply the updated data to the user interface parameters to alter the features of the user interface theme.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIG. 10, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method, comprising:
receiving, by a mobile device and from a user, parameters for a user interface theme associated with an application, wherein the user interface parameters define conditions for altering features of the user interface theme based on variable data fields;
verifying, by the mobile device, compatibility of the user interface parameters;
obtaining, by the mobile device, data for the user interface parameters that corresponds to the variable data fields;
applying, by the mobile device, the obtained data to the user interface parameters to generate features of the user interface theme;
monitoring, by the mobile device, the variable data fields to obtain updated data; and
applying, by the mobile device, the updated data to the user interface parameters to alter the features of the user interface theme.

2. The method of claim 1, further comprising:
presenting, by the mobile device, a configuration interface to solicit the user interface parameters.

3. The method of claim 1, further comprising:
storing, in a memory of the mobile device, the user interface parameters.

4. The method of claim 1, wherein the variable data fields include information specific to a subscriber account associated with the mobile device.

5. The method of claim 4, wherein the variable data fields include one or more of:
a mobile data use field for the subscriber account,
a text messaging use field for the subscriber account, or
a voice minutes use field for the subscriber account.

6. The method of claim 1, wherein the obtaining data for the user interface parameters includes:
providing credentials, for the mobile device, to a server device, and
receiving, from the server device, the data for the user interface parameters.

7. The method of claim 1, wherein the verifying compatibility of the user interface parameters includes:
comparing the user interface parameters to identify conflicting conditions for one or more features.

8. The method of claim 1, wherein applying the updated data to the user interface parameters to alter the features of the user interface theme includes altering one or more of:
a color,
an image,
a font type, or
an icon.

9. The method of claim 1, wherein the variable data fields include information specific to a particular event or particular entity.

10. The method of claim 9, wherein the particular event includes one or more of:
a sporting event,
a financial event, or
a weather event.

11. A mobile device, comprising:
a memory to store instructions and an application including a user interface client;
a transceiver to transmit and receive signals over a wireless network; and
a processor configured to execute the instructions in the memory to:
present a configuration interface to solicit user interface parameters for a user interface theme associated with the application,
receive, from a user, the user interface parameters, wherein the user interface parameters define conditions for altering features of the user interface theme based on variable data fields,
verify compatibility of the user interface parameters,
obtain data for the user interface parameters that corresponds to the variable data fields,
apply the obtained data to the user interface parameters to generate features of the user interface theme,
monitor the variable data fields to obtain updated data, and
apply the updated data to the user interface parameters to alter the features of the user interface theme.

12. The mobile device of claim 11, wherein the processor is further configured to:
store, in the memory, the user interface parameters.

13. The mobile device of claim 11, wherein, when obtaining data for the user interface parameters that corresponds to the variable data fields, the processor is further configured to:
request, from a remote server device, information specific to a subscriber account associated with the mobile device.

14. The mobile device of claim 13, wherein the information specific to the subscriber account includes one or more of:
mobile data use for the subscriber account,
text messaging use for the subscriber account, or
voice minute use for the subscriber account.

15. The mobile device of claim 11, wherein, when obtaining data for the user interface parameters that corresponds to the variable data fields, the processor is further configured to:
solicit express authorization from the user.

16. The mobile device of claim 11, wherein, when obtaining data for the user interface parameters, the processor is further configured to:
provide, to a server device, credentials for the mobile device, and
receive, from the server device, the data for the user interface parameters.

17. The mobile device of claim 11, wherein, when verifying compatibility of the user interface parameters, the processor is further configured to:
compare the user interface parameters to identify conflicting conditions for one or more features.

18. A non-transitory computer-readable medium comprising computer-executable instructions, the computer-readable medium comprising one or more instructions to:
present a configuration interface to solicit user interface parameters for a user interface theme associated with an application;
receive, from a user, the user interface parameters, wherein the user interface parameters define a first condition for altering a first feature of the user interface theme based on a first variable data field and a second condition for altering a second feature of the user interface theme based on a second variable data field;
verify compatibility of the user interface parameters;
obtain data for the user interface parameters that corresponds to the first variable data field and the second variable data field;
apply the obtained data to the user interface parameters to generate the first feature and the second feature of the user interface theme;
monitor the first variable data field and the second variable data field to obtain updated data for at least one of the first variable data field or the second variable data field; and
apply the updated data to the user interface parameters to alter the first feature or the second feature of the user interface theme.

19. The non-transitory computer-readable medium of claim 18, wherein the one or more instructions to obtain data for the user interface parameters that corresponds to the first variable data field and the second variable data field further include:
one or more instructions to request, from a remote server device, information specific to a subscriber account associated with the mobile device.

20. The non-transitory computer-readable medium of claim 19, further comprising one or more instructions to:
receive, from a user, credentials for obtaining data for the user interface parameters;
store, in a local memory, the credentials; and
provide, to the remote server, the credentials along with the requesting information specific to the subscriber account.
